(19) United States
(12) Patent Application Publication
(10) Pub. No.: US 2005/0189527 A1
(43) Pub. Date: Sep. 1, 2005

(54) Aerial cable placing machine

(76) Inventor: Robert A. Young, Warrington, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/045,798

(22) Filed: Jan. 28, 2005

Related U.S. Application Data
(63) Continuation of application No. PCT/US03/23762, filed on Jul. 30, 2003.
(60) Provisional application No. 60/399,844, filed on Jul. 30, 2002.

(51) Int. Cl. H02G 1/06

(52) U.S. Cl. 254/134.3 R

(57) ABSTRACT

An aerial cable placing truck is provided. The truck includes a stringing apparatus which includes a full castoring bullwheel system for positioning a cable. The stringing apparatus pivots from side to side for placing cable on either side of the truck. The truck also includes a cantilevered turret for supporting a boom. The cantilevered turret is positioned to provide an open deck cable route along the truck deck for the cable so that the cable may taken off the truck without cutting the cable from the cable reel. A live fairlead may also be included to provide an indication of fairlead load separate from basket load.

### FIELD OF THE INVENTION

The present invention relates generally to an aerial cable placing machine and in particular but not exclusively to a truck for placing aerial cable.

### BACKGROUND OF THE INVENTION

Many available aerial cable placing machines are outdated and do not reflect the present needs of cable stringing applications, such as cable TV and telecommunication applications. Moreover existing machines may merely be modifications of machines originally intended for other purposes, such as a converted digger derrick boom, for example. Such machines are not designed from the ground up for use as a cable stringing machine, and, therefore, suffer from various deficiencies. For example, the weight, stability, stringing apparatus, reel loading, reel driving capabilities, load monitoring, component design and ergonomics are areas in which major improvements can be made. In sum, a need exists in the market for an aerial cable placing machine that is well thought out and is well suited to the various applications of aerial construction, such as cable TV and telecommunication applications.

### SUMMARY OF THE INVENTION

An aerial cable placing truck is provided having a frame and a truck deck supported relative to the frame. The truck includes a stringing apparatus which includes a full castoring bullwheel system for positioning a cable. The stringing apparatus pivots from side to side for placing cable on either side of the truck. The truck also includes a cantilevered turret offset to one side of the deck for supporting a boom. The cantilevered turret is positioned to provide an open deck cable route along the truck deck for the cable so that the cable may taken off the truck without cutting the cable from the reel. A live fairlead may also be included to provide an indication of fairlead load separate from basket load.

### BRIEF DESCRIPTION OF THE DRAWINGS

The foregoing summary and the following detailed description of the preferred embodiments of the present invention will be best understood when read in conjunction with the appended drawings, in which:

FIGS. 1-4 illustrate perspective views of a model of a truck in accordance with the present invention;

FIG. 5 illustrates a cable reel loader and driver system in accordance with the present invention;

FIG. 6 illustrates a perspective view of a cantilevered turret mount and strand reel;

FIGS. 7-9 illustrate perspective views showing the stringing apparatus, cantilevered turret mount, and strand reel;

FIG. 10 illustrates a perspective view of the stringing apparatus;

FIGS. 11-13 illustrate perspective views showing the basket, stirrup load transfer system, and fairlead assembly;

FIGS. 14A and 14B illustrates side elevational views of the fairlead assembly; and

FIG. 15 illustrates a cross-sectional view of the boom.

### DETAILED DESCRIPTION OF THE INVENTION

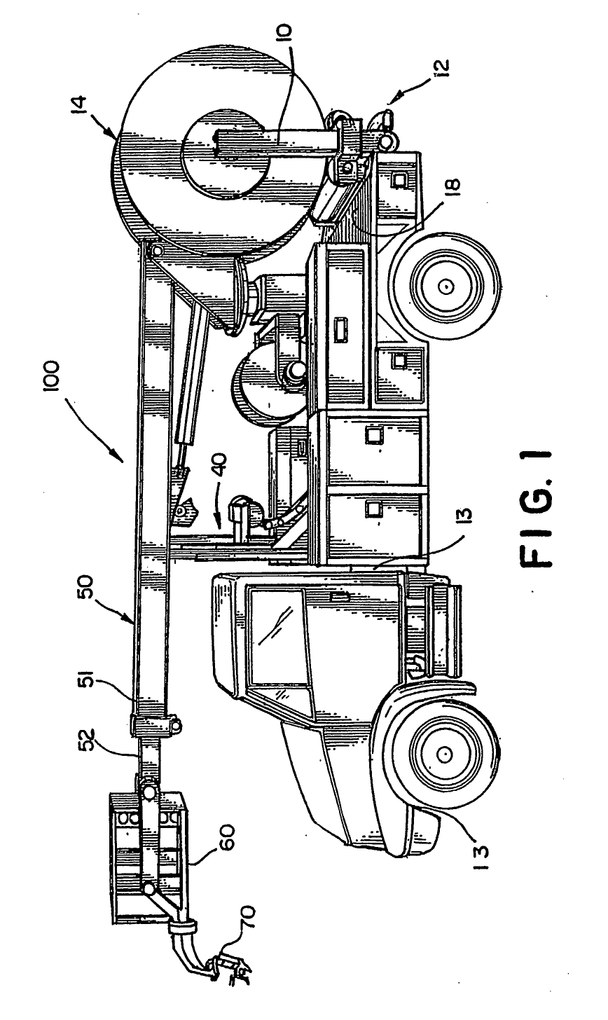

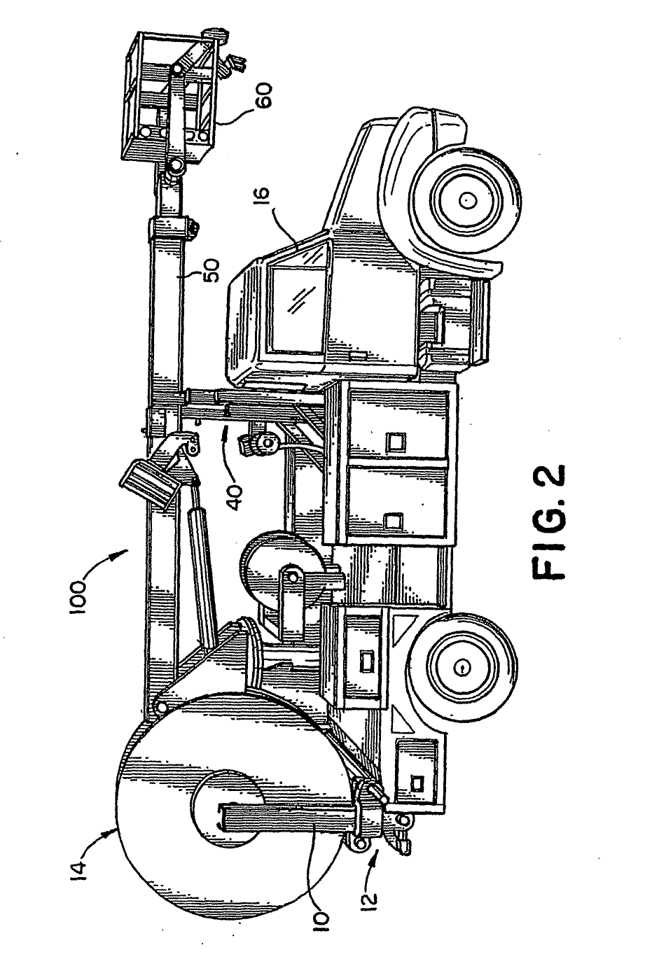

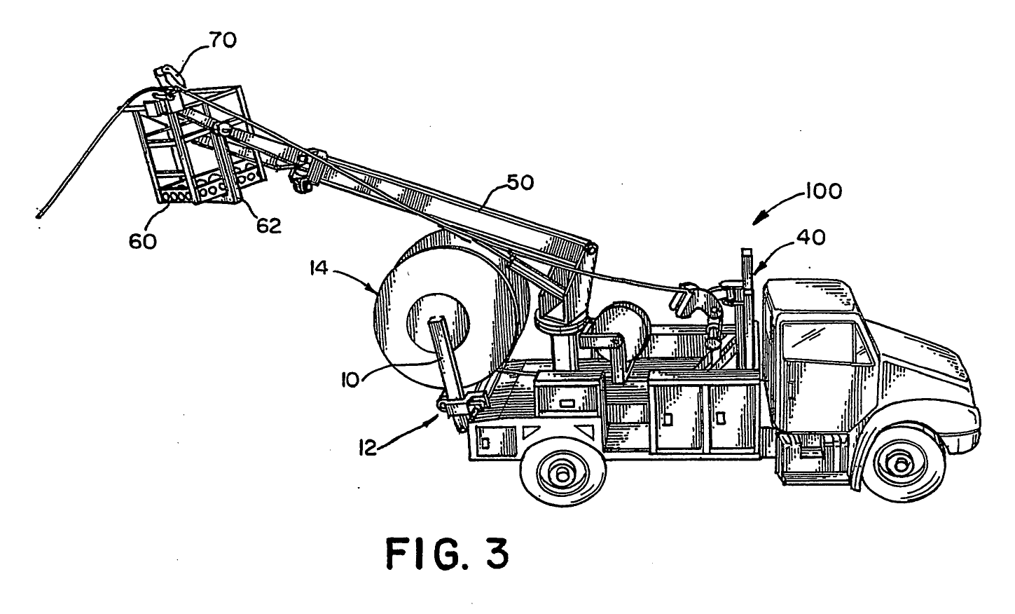

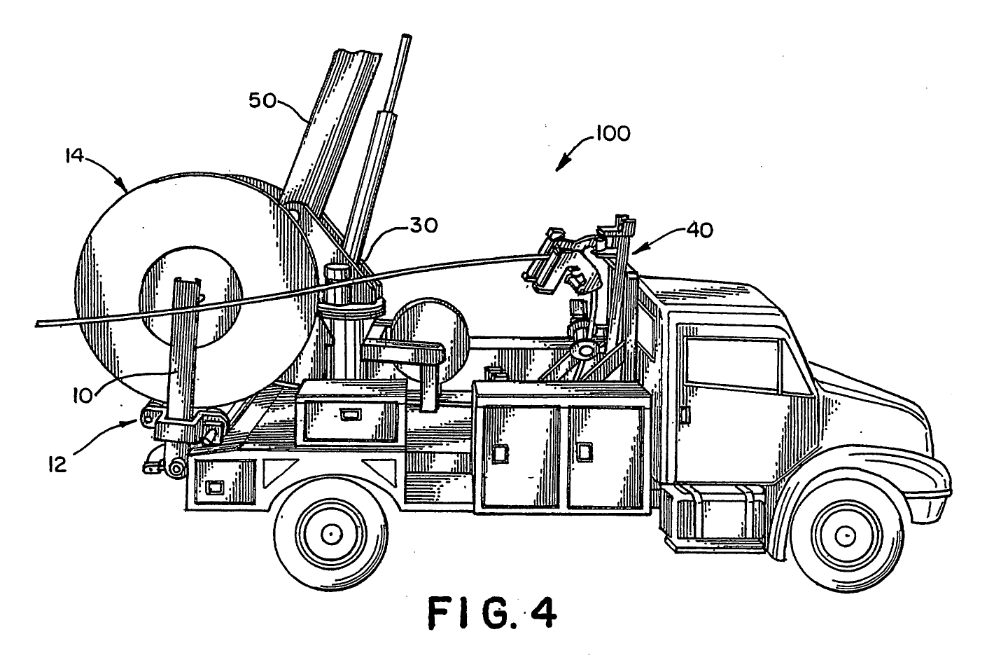

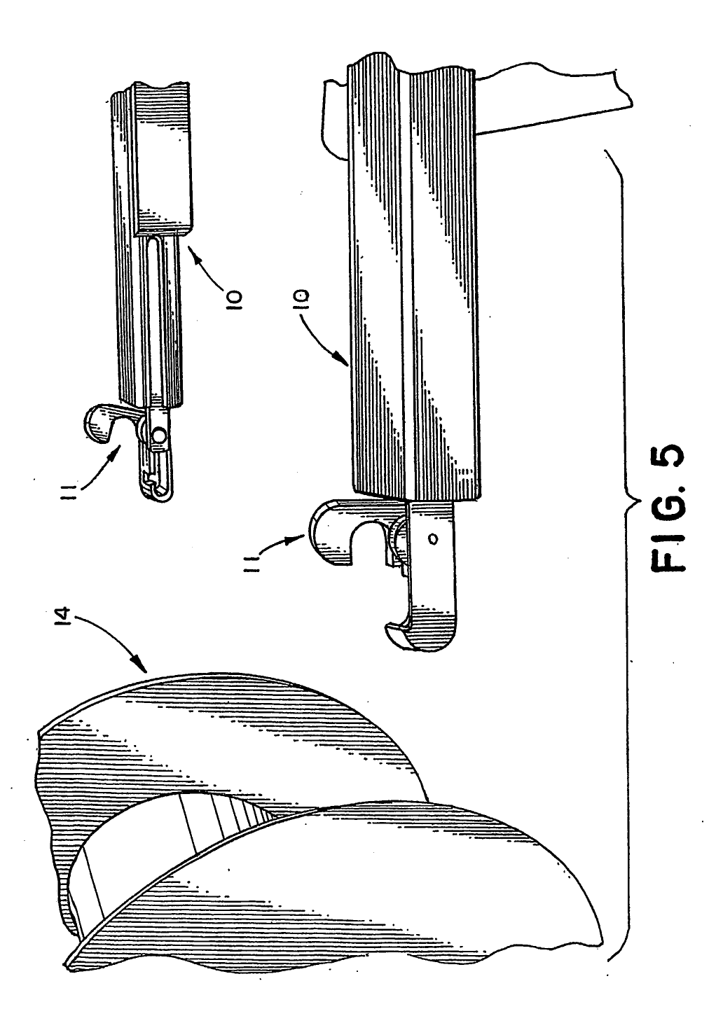

Referring now to the figures, wherein like elements are numbered alike throughout, one configuration of a truck, generally designated 100, in accordance with the present invention is illustrated, as shown in FIGS. 1-4. The truck 100 includes a frame 13 and a deck 18 supported relative to the frame. The truck 100 comprises a reel loader and driver assembly 12 for lifting a cable reel 14 into position. The reel loader assembly 12 includes two reel loader arms 10 that may be telescopically extendable, each of which includes a reel lock 11 at a distal end for retaining the cable reel 14, as shown in FIG. 5. The drive portion 20 of the loader and driver assembly 12 may be a hydra-static rim drive assembly to allow for heavy aerial or underground winch capability, e.g., generating 15,000#-20,000# of line pull. The loader arms 10 may be hydraulically driven so as to extend, such as telescopically, toward a reel of cable, as shown in FIG. 5, until the hydraulically driven reel lock is in position to automatically grasp and lock onto the ends of reel. The arms 10 may then be hydraulically driven to retract the arms 10 to pull the reel toward the truck and then pivoted upward to lift the reel at the rear deck of the truck, as shown in FIGS. 1-4.

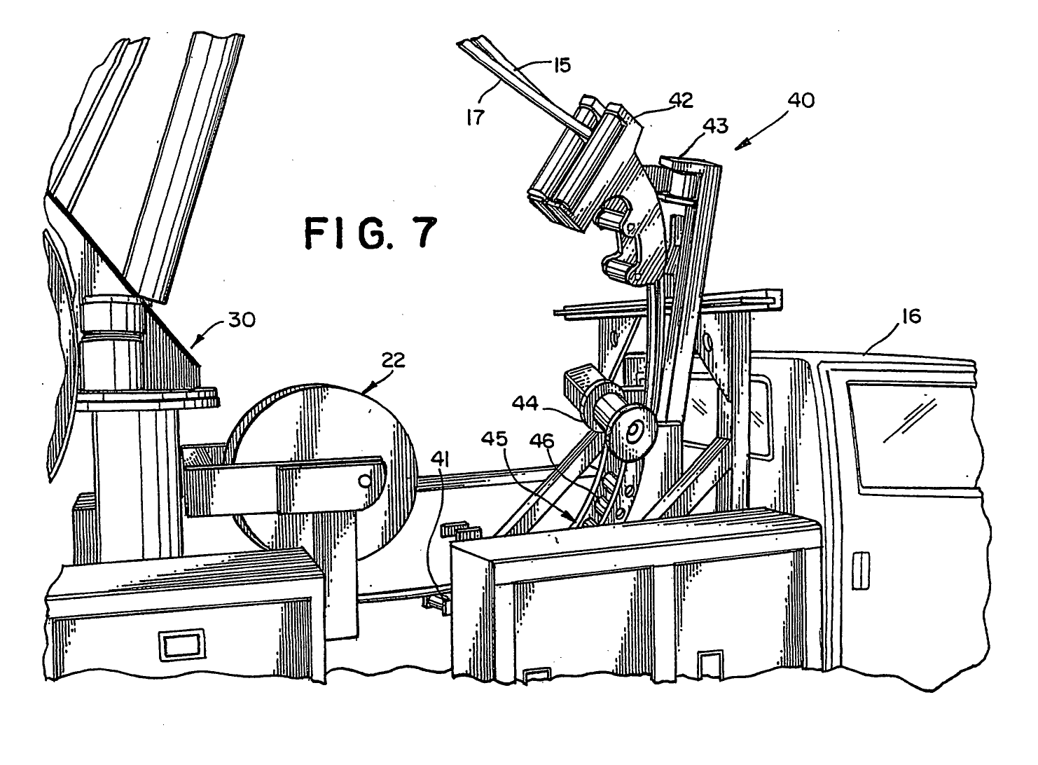

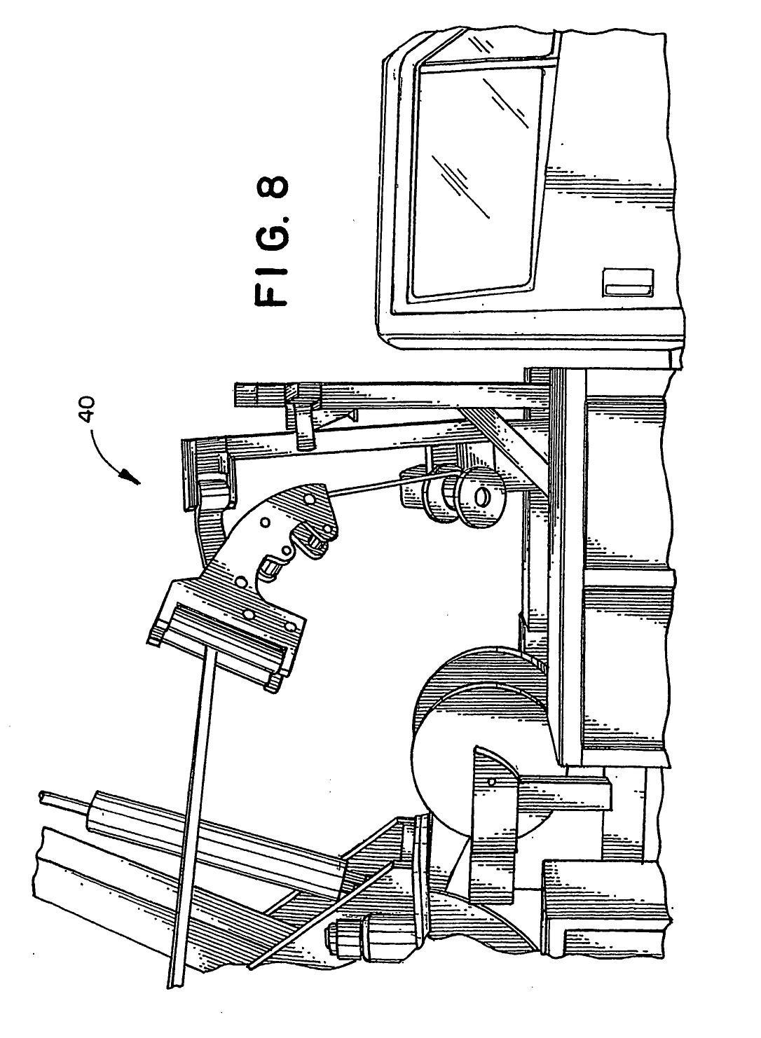

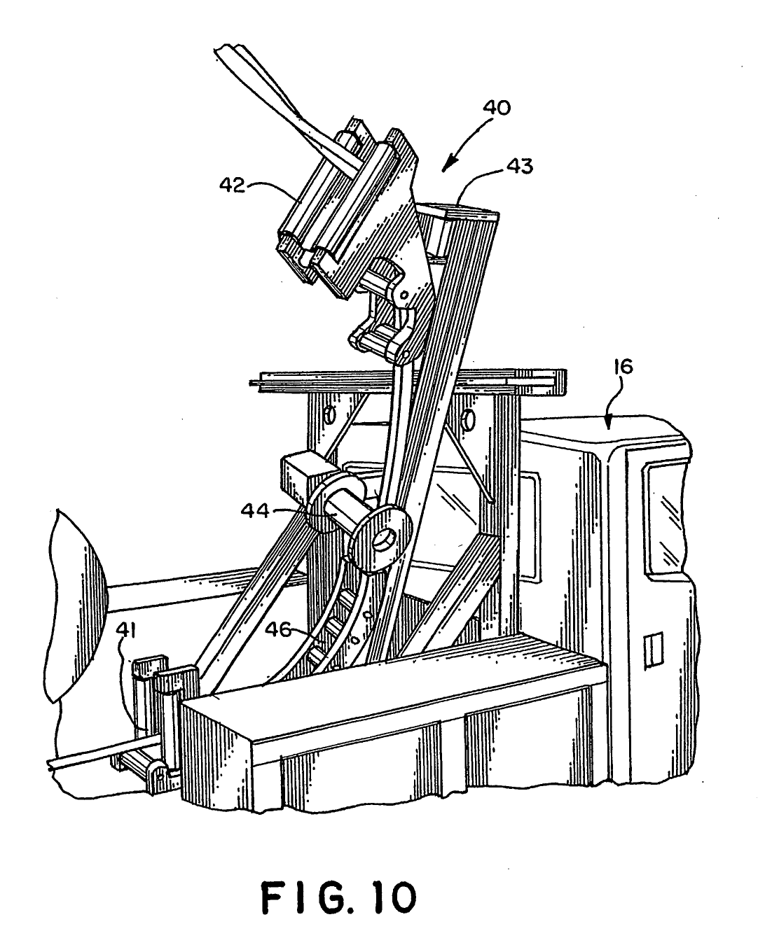

Turning now to FIGS. 7-10, the truck 100 further comprises a stringing apparatus 40 which includes a full castoring bullwheel system 45. The stringing apparatus 40 is designed to accommodate all products including a strand 17. The stringing apparatus 40 is mounted on the deck 18 centrally behind the cab 16 of the truck 100. The stringing apparatus 40 pivots from side to side relative to the deck 18 for placing cable 15 on either side of the truck 100. The side-to-side pivoting allows for a true arch over the heel of a boom 50 when the truck 100 crosses from one side of the street to the other during cable placing operations. The stringing apparatus 40 comprises a lower bullwheel 46 and an upper swivel bullwheel 42 which swivels about swivel point 43. In addition, a tow-line winch 44 may be mounted to the stringing apparatus 40. The tow-line winch 44 may be used to pull a cable lasher, for example. Optionally, a pre-ashing apparatus may be provided proximate the upper swivel bullwheel 42. The pre-ashing apparatus may be a wire-driven cable lasher or a strand-driven cable lasher. The pre-ashing apparatus floats or rides the tangent of the product, i.e., cable, exiting the upper swivel bullwheel 42.

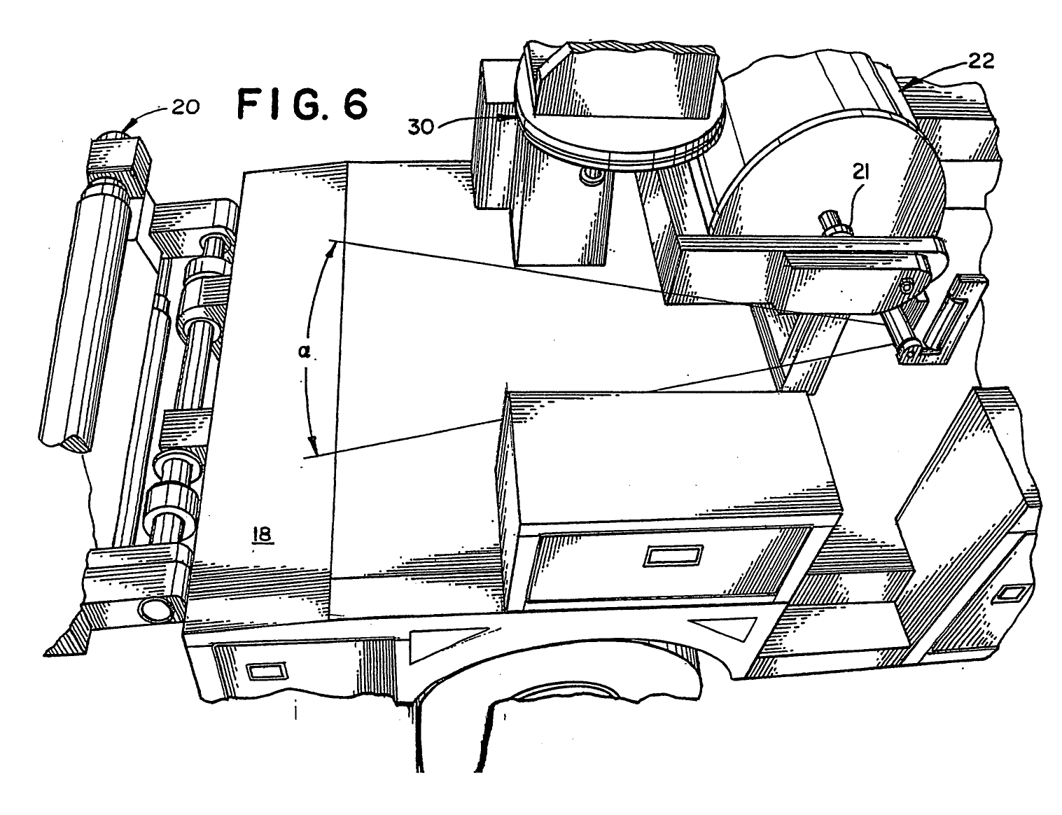

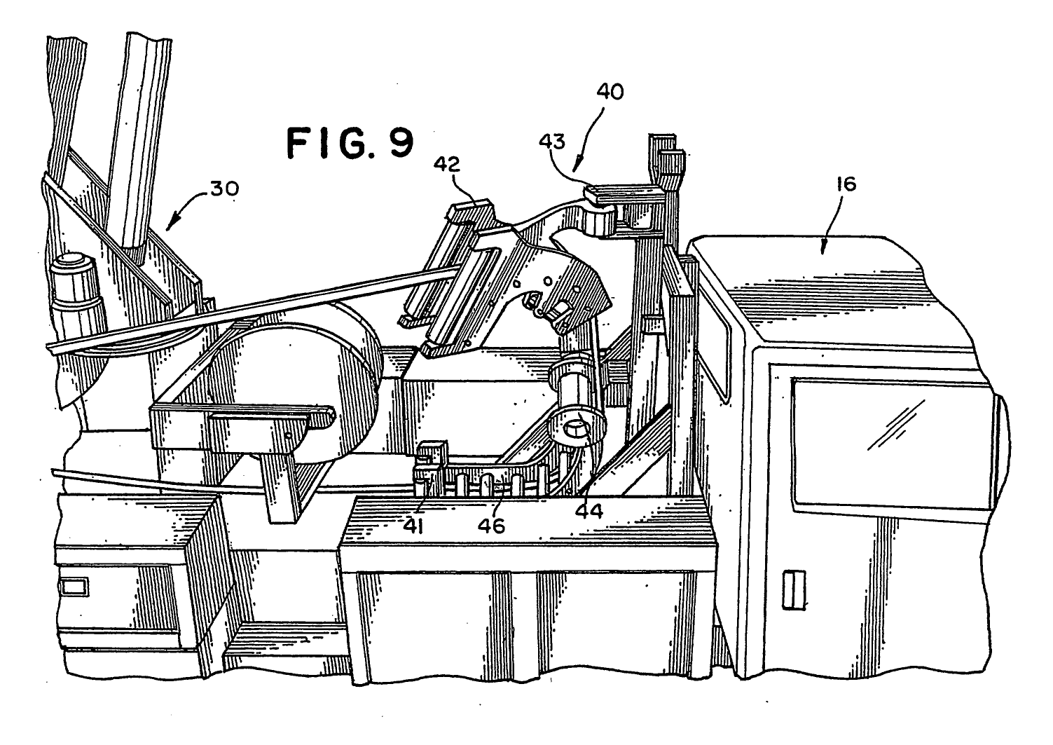

The cable 15 pay-off from the cable reel 14 traverses an open deck cable route along the truck deck 18 to engage the stringing apparatus 40, as seen in FIGS. 6 and 9. The open deck 18 provides a wide angle, as shown in FIG. 6, to feed cable from the drive 20 for the reel at the rear of the truck to the stringing apparatus 40. The cable 15 enters the stringing apparatus 40 at an entry point 41 at deck level, passes along the lower bullwheel 46 and into the upper swivel bullwheel 42. The strand 17 pay-off from the strand reel 22 may enter the stringing apparatus at the same entry point 41 as the cable 15. The truck 100 may include a combination back drive and brake system for both the reel loader assembly 12 and a strand spindle 21 on which the strand reel 22 is mounted.

A turret 30 is provided on the deck 18 for supporting a boom 50 at a proximal end, as shown in FIG. 6. The boom 50 supports a basket 60 at the distal end to provide a platform from which an operator may place an aerial cable. The turret 30 is mounted in such a manner so as to be offset to one side of the deck 18 to clear the deck 18 of obstructions and to allow for a long fleet angle α for the cable routing from cable reel 14 to the stringing apparatus 40, as shown in FIG. 6. The turret 30 is mounted in a cantilevered or offset configuration that allows the cable 15 to be taken off the truck 100 without cutting it from the cable reel 14. As an alternative to a cantilevered configuration, a bridge that spans the width of the deck 18 may be provided to support the boom 50. To permit the cable 15 to be taken off the truck without cutting it from the cable reel 14, the bridge may include an opening, or a section which may be opened, to permit the cable 15 to pass through the opening or section. A boom turret rotation system is also provided to permit continuous boom rotation. The boom turret rotation system has side load protection and provides 1000 pounds minimum of side pull, for example, at full extension.

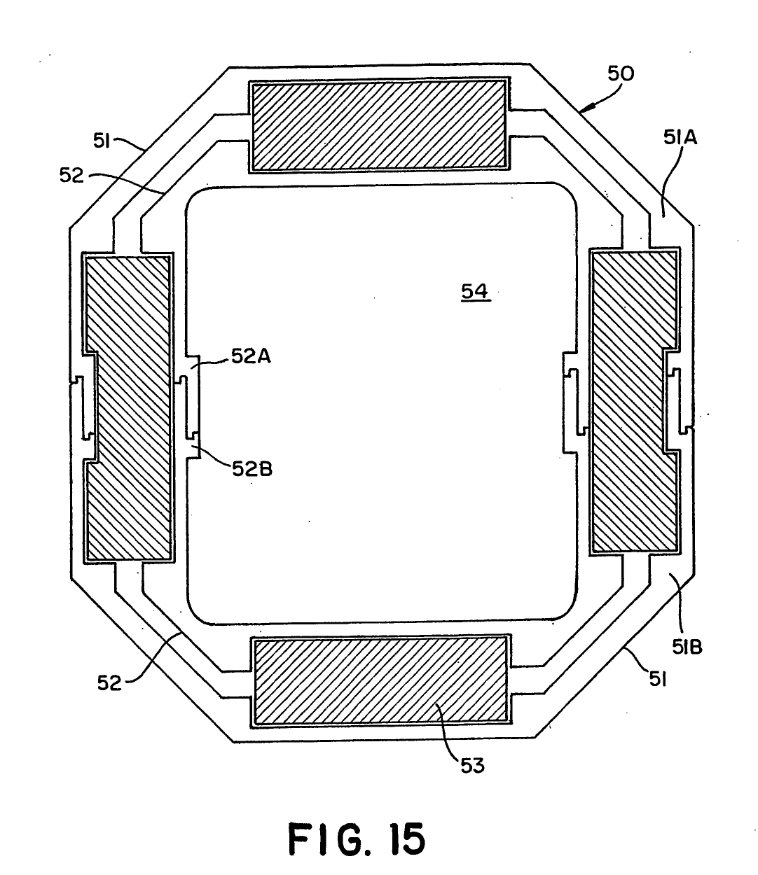

The boom 50 may be fabricated from extruded aluminum and may comprise two telescoping sections 51 and 52, as shown in FIGS. 1 and 15. Each respective section 51 and 52 may be formed from asymmetrical half sections 51A and 51B and 52A and 52B, respectively, that may be rotated and then mated and joined together to form sections 51 and 52. The respective half sections 51A and 51B (or 52A and 52B) may be formed from the same mold or extrusion die. A glide element 53 may be disposed between the telescoping sections 51 and 52, as shown in FIG. 15, to permit adequate support and smooth telescoping operation. The boom includes a hollow interior 54, as shown in FIG. 15. Such a hollow, two part structure may provide weight savings of as much as 50% over presently available booms. The weight savings in the boom 50 could be traded for increased boom extension, increased allowable boom loading, additional payload on the truck, or a combination of these.

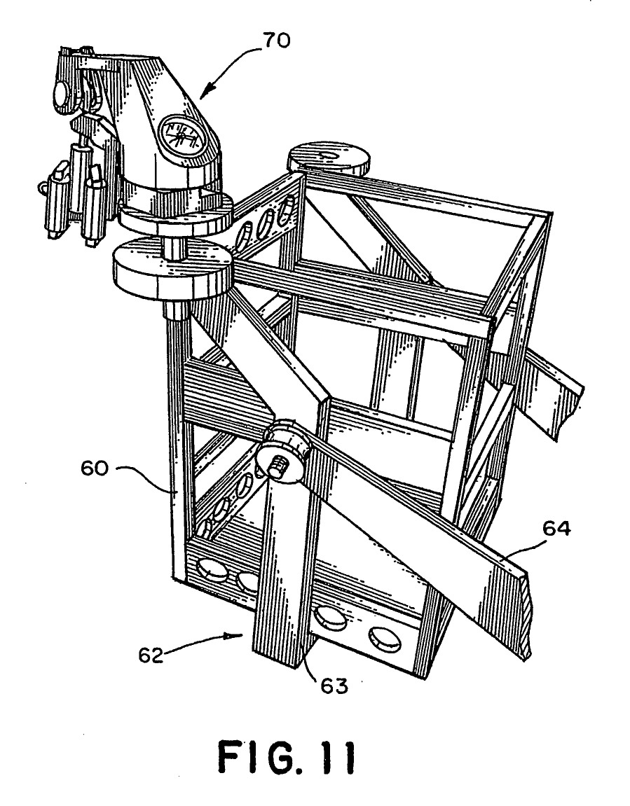

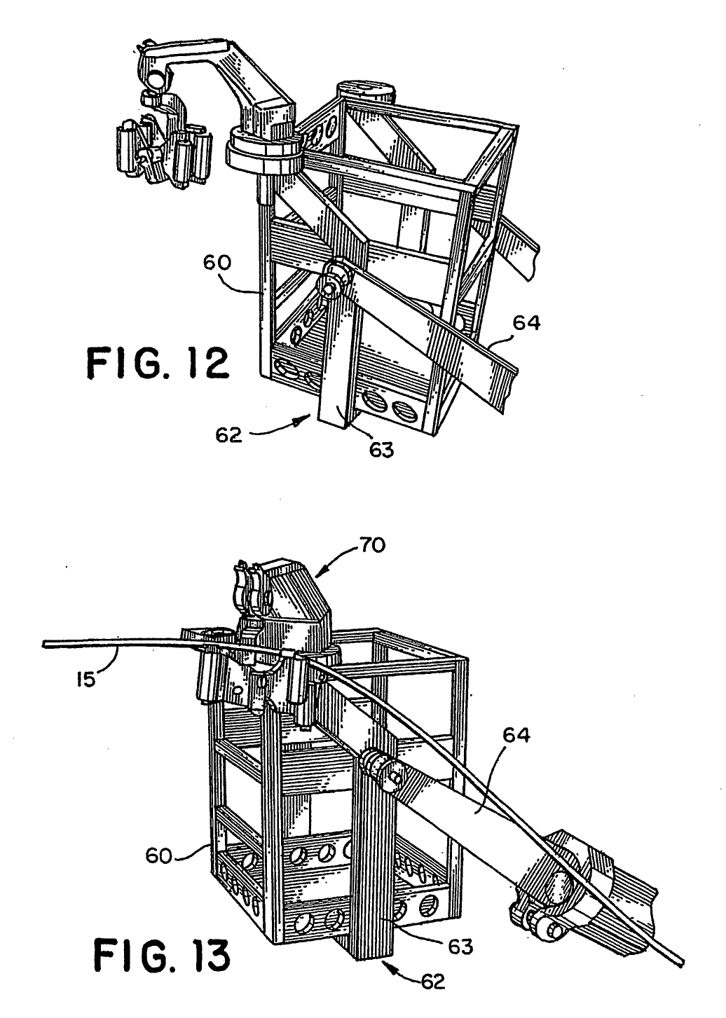

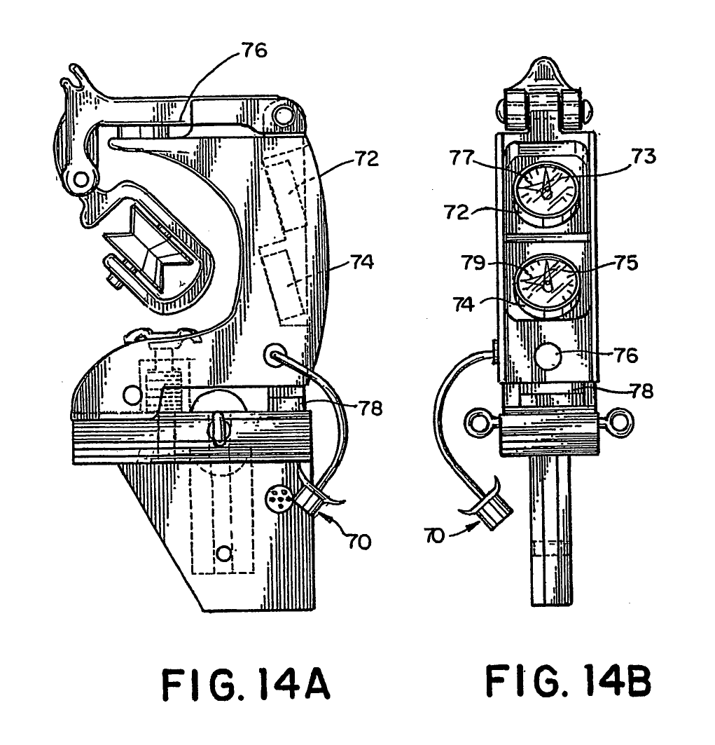

As shown in FIGS. 11-13, a basket 60 is held at the distal end of the boom 50 by a fork-arm 64. A stirrup load transfer system 62 is provided in the form of a U-shaped support 63 for distributing the pulling forces exerted on the basket during cable installation. Distribution of the pulling forces can lessen the chance of bending of the fork-arm 64. Consequently, the stirrup load transfer system 62 may increase or even double the load capability of the fork-arm assembly over similar non-stirrup systems. A “live” fairlead 70 may also be provided at the basket 60, as illustrated in FIGS. 11-14. The live fairlead 70 may be controlled by a suitable microprocessor to measure, record and display loads at the fairlead. The live fairlead 70 has a down-load cell 76 and a side-load cell 78, which measure the down-load and side-load, respectively. The down-load and side-load are displayed on a down-load gauge 72 and a side-load gauge 74. Providing an indication of the side-load and down-load at the live-fairlead 70 enables the fairlead load to be separately indicated from the basket load. The down-load and side-load gauges 72, 74 may be digital displays or, alternatively, may be analog displays, as shown in FIGS. 14A and 14B, whereby each includes a needle 73, 75 that indicates the maximum allowable load and a needle 77 and 79 that indicates current load. The location of the needles 73, 75 change according to the degree of boom 50 extension, as shown in FIGS. 14A and 14B. The measured load information may be stored for future downloading. An optional tension meter or gauge 76 may be provided to indicate tension on the line or cable.

In addition to the above features, several additional features may be provided, such as: an ergonomically designed basket with tool boxes and accessories; transferable (pendant) basket controls; a hydraulic cylinder that moves the stringing apparatus 40 from side to side; transfer bar to move the driver to different index positions; and reel brakes.

### EXAMPLE

FIGS. 1-13 illustrate a wooden 3/32″ scale model of one conceptual configuration of a truck in accordance with the present invention. Hence, there are some deviations, omissions, and liberties taken with the scale where the detail cannot be supported by the scale or materials used. Even with the deviations, the model represents several basics concepts of the invention with the following overall specifications, features and benefits:
Platform Height=37′10″
Side Reach=30′
Reel Loader=6000#, 84″ diameter reel (stows vertically) Self Locking reel loader mechanism
Maximum Travel Height=12′
30″×30″×42″ Basket
32″ diameter upper and lower bullwheel assembly (each—110 degree radius)

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. An aerial cable placing truck, comprising:
A. a frame;
B. a deck supported relative to the frame;
C. a stringing apparatus supported relative to the frame having a full castoring bullwheel system for positioning a cable;
D. A boom for aerially deploying the cable from the bull wheel system; and
E. a cantilevered turret for supporting the boom, the cantilevered turret positioned to provide an open deck cable route along the deck for the cable.

2. An aerial cable placing truck, comprising:
A. a frame; and
B. a boom assembly supported relative to the frame to enable the placement of aerial cable, the boom assembly including a boom arm and two half sections that mate together to form the boom arm.

3. The aerial cable placing truck of claim 2 wherein the boom arm is configured with a generally hollow interior.

4. An aerial cable placing truck comprising:
A. a frame;
B. a deck supported relative to the frame;
C. a boom to enable the placement of aerial cable; and
D. a turret mounted in an offset location toward one side of the deck for supporting the boom.

5. An aerial cable placing truck comprising:
A. a frame;
B. a deck supported relative to the frame;
C. a stringing apparatus pivotally mounted relative to the deck to enable the stringing apparatus to pivot from one side of the deck to the other side of the deck to facilitate the aerial placement of cable on either side of the deck.

6. An aerial cable placing truck comprising:
A. a frame;
B. a deck supported relative to the frame; and
C. a reel loader assembly supported relative to the deck including two reel loader arms that are hydraulically driven to engage and lift a reel of cable.

7. The aerial cable placing truck of claim 6, including a self-locking reel lock on each loader arm for engaging and retaining the reel in position on the loader arms.

8. An aerial cable placing truck including:
A. a frame;
B. a deck supported relative to on the frame;
C. a boom arm supported relative to the deck;
D. a fork arm supported on an end of the boom arm;
E. a U-shaped support mounted on the fork arm; and
F. a bucket for holding a person supported on the fork arm and cradled by the U-shaped support.

9. An aerial cable placing truck comprising:
A. a frame;
B. a deck supported relative to the frame;
C. a boom arm supported relative to the deck;
D. a fairlead supported at an end of the boom arm having at least one load cell to measure a selected load at the end of the boom arm.

10. The aerial cable placing truck of claim 9 wherein the load cell includes a down-load cell to indicate downward loading at the fairlead.

11. The aerial cable placing truck of claim 9 wherein the load cell includes a side-load cell to indicate sideward loading at the fairlead.
